(19) United States
(12) Patent Application Publication
(10) Pub. No.: US 2022/0106896 A1
(43) Pub. Date: Apr. 7, 2022

(54) CATALYTIC CONVERTER HEATING ELEMENT

(71) Applicant: Ford Global Technologies, LLC, Dearborn, MI (US)

(72) Inventors: Justin Lloyd, Westcliff on Sea (GB); Marcus Timothy Davies, Rochester (GB); Marie Louise Nunn, Southend-on-Sea (GB)

(21) Appl. No.: 17/062,707

(22) Filed: Oct. 5, 2020

(51) Int. Cl. F01N 3/20; F01N 11/00

(52) U.S. Cl. CPC F01N 3/2013; F01N 11/007; F01N 11/002; F01N 2900/1624; F01N 2560/025; F01N 2560/06; F01N 2900/1602; F01N 2240/16

(57) ABSTRACT

A method of controlling a heating element for providing heat to a catalyst of a catalytic converter, the method comprising: determining a catalyst performance characteristic as a function of time, and varying the amount of heating provided by the heating element in response to a change in the catalyst performance characteristic being greater than a predetermined amount.

### BACKGROUND

The present disclosure relates to systems and methods for controlling a heating element for providing heat to a catalytic converter and, more particularly, but not exclusively, to systems and methods related to actively varying the amount of heating provided by the heating element.

### SUMMARY

The need for reduced engine emissions has led to engine exhaust systems that comprise catalytic converters. Catalytic converters are located within a structure/housing in the exhaust system, such as a can that is designed to contain and direct exhaust gases over and/or through the catalytic converter. A support structure, such as a support mat, is typically used to hold the catalytic converter in a desired location within the exhaust system (e.g., the support mat may be provided in-between the inner wall of a can and the surface of the emission treatment component).

The majority of internal combustion pollutants are generated during the relatively cold start phase of an engine, where the temperature of the catalyst is below its optimum operating window. In order to improve performance of the catalytic converter in the start phase, gasoline engines use spark retardation in order to provide heat to the catalyst. This leads to running the engine inefficiently for a period of time. Further, this method requires the engine to be running and so the engine is already emitting pollutants whilst the catalyst is outside of the optimum operating window.

Additionally, as the catalyst is exposed to high temperature poisons during normal use, the catalyst efficiency degrades with time (for example, phosphorous covering a surface of the catalyst). The catalyst may also clump with time, which reduces the surface area of the catalyst and hence the efficiency of the catalyst.

In view of the foregoing, the present disclosure provides a method of controlling a heating element for providing heat to a catalyst of a catalytic converter that improves the performance of the catalytic converter and that is less complex and expensive than conventional systems.

In accordance with a first aspect of the disclosure, there is provided a method of controlling a heating element for providing heat to a catalyst of a catalytic converter. The method comprises determining a catalyst performance characteristic, e.g., as a function of time. The method comprises varying the amount of heating provided by the heating element, e.g., in response to a change in the catalyst performance characteristic being greater than a predetermined amount. Types of catalyst performance characteristics that may be utilized are discussed in more detail below. However, in general, a catalyst performance characteristic is any value that can be measured and used to infer a decrease in catalyst performance.

The heating element may be configured to allow the catalyst to be heated in a manner that is independent of the temperature of the exhaust from the engine. The catalyst may be heated by the heating element before the engine is even turned on, for example when a user unlocks a vehicle. In some examples, the heating element could be used to heat the catalyst so that spark retardation is not needed. Once the catalyst reaches the optimum temperature/temperature window, the heating element may no longer actively provide heat.

In some variations, the catalyst performance characteristic comprises a catalyst oxygen storage value. The method may comprise determining whether the catalyst oxygen storage value has decreased with respect to a stored catalyst oxygen storage value and in response to determining that the catalyst oxygen storage value has decreased, instructing the heating element to provide more heat to the catalyst.

In some variations, the catalyst performance characteristic may comprise first and second catalyst oxygen sensor values, the first catalyst oxygen sensor value corresponding to a first end of the catalyst and the second catalyst oxygen sensor value corresponding to an opposing second end of the catalyst. The method may comprise: determining a difference between the first catalyst oxygen sensor value and the second catalyst oxygen sensor value, determining whether the difference between the first catalyst oxygen sensor value and the second catalyst oxygen sensor value has decreased with respect to a stored catalyst oxygen sensor difference value and in response to determining that the difference between the first catalyst oxygen sensor value and the second catalyst oxygen sensor value has decreased, instructing the heating element to provide more heat to the catalyst.

Measuring an oxygen storage value allows, for example, more heat to be applied to the catalyst as the catalyst ages and becomes less efficient with time, thereby at least partially overcoming the inefficiency associated with catalyst aging. Additional oxygen sensors may be utilized, for example at a mid-point(s) of the catalyst, enabling a more detailed picture of the oxygen storage value to be determined at different points along the catalyst.

In some variations, the catalyst performance characteristic may comprise a temperature value. The method may comprise: determining whether the temperature value has decreased with respect to a stored temperature value and in response to determining that the temperature value has decreased, instructing the heating element to provide more heat to the catalyst. Such a method helps to ensure that the catalyst is operating in the optimum temperature window and by applying heat to the catalyst if it is below the optimum temperature window.

In some variations, the catalyst performance characteristic may comprise an accumulated catalyst usage value. The method may comprise: determining whether the accumulated catalyst usage value has increased above a threshold value and in response to determining that the accumulated catalyst usage value has increased above the threshold amount, instructing the heating element to provide more heat to the catalyst.

In some variations, the catalytic converter may be part of a vehicle. The catalyst performance characteristic may comprise a value indicating a distance travelled by the vehicle. The method may comprise: determining whether the value indicating a distance travelled by the vehicle has increased above a threshold value and in response to determining that the value indicating a distance travelled by the vehicle has increased above the threshold amount, instructing the heating element to provide more heat to the catalyst.

In some variations, the catalytic converter may be attached to an engine. The catalyst performance characteristic may comprise a value indicating a number of hours the engine has run. The method may comprise: determining whether the value indicating a number of hours the engine has run has increased above a threshold value and in response to determining that the value indicating a number of hours the engine has run has increased above the threshold amount, instructing the heating element to provide more heat to the catalyst.

Methods that determine accumulated catalyst usage, distance travelled and/or hours that the engine has run allows inefficiencies associated with catalyst aging to be, at least partially, mitigated by applying additional heat to the catalyst.

In accordance with a second aspect of the disclosure, there is provided a method of controlling a heating element for providing heat to a catalyst of a catalytic converter. The heating element comprises a plurality of independently controllably electrical elements. The method comprises: controlling a first electrical element of the plurality of electrical elements to provide heat to a first part of a catalyst, controlling a second electrical element of the plurality of electrical elements to provide heat to a second part of a catalyst, determining a catalyst performance characteristic as a function of time and varying the amount of heating provided by at least one of the first electrical element and the amount of heating provided by the second electrical element in response to a change in the catalyst performance characteristic being greater than a predetermined amount. Types of catalyst performance characteristics that may be utilized are discussed in more detail below. However, in general, a catalyst performance characteristic is any value that can be measured and used to infer a decrease in catalyst performance.

Such a method allows for different catalyst aging profiles to be, at least partially, mitigated. For example, more heat might be applied to a front portion of the catalyst as it receives gas with a relatively higher portion of poisons than a rear portion of the catalyst.

In some variations, the catalyst performance characteristic may comprise first and second catalyst oxygen storage values. The first catalyst oxygen storage value may correspond to a first end of the catalyst. The second catalyst oxygen storage value may correspond to an opposing second end of the catalyst. The method may comprise: determining whether the first catalyst oxygen storage value has decreased with respect to a first stored catalyst oxygen storage value, determining whether the second catalyst oxygen storage value has decreased with respect to a second stored catalyst oxygen storage value, in response to determining that the first catalyst oxygen storage value has decreased, instructing the first electrical element to provide more heat to the first end of the catalyst and in response to determining that the second catalyst oxygen storage value has decreased, instructing the second electrical element to provide more heat to the second end of the catalyst.

In some variations, the catalyst performance characteristic may comprise first and second catalyst temperature values. The first catalyst temperature value may correspond to a first end of the catalyst. The second catalyst temperature value may correspond to an opposing second end of the catalyst. The method may comprise: determining whether the first catalyst temperature value has decreased with respect to a first stored temperature storage value, determining whether the second catalyst temperature value has decreased with respect to a second stored catalyst temperature storage value, in response to determining that the first catalyst temperature value has decreased, instructing the first electrical element to provide more heat to the first end of the catalyst and in response to determining that the second catalyst temperature value has decreased, instructing the second electrical element to provide more heat to the second end of the catalyst.

In accordance with a third aspect of the disclosure, there is provided a heating element for providing heat to a catalyst of a catalytic converter. The heating element comprises a plurality of independently controllable electrical elements configured to, in use, provide a first electrical element of the plurality of electrical elements can provide a first amount of heat to a first part of the catalyst and a second electrical element of the plurality of electrical elements can provide a second amount of heat to a second part of the catalyst.

In some variations the catalytic converter may comprise an insulating material. At least a part of the heating element may be embedded the insulating material. At least a part of the heating element may be attached to a surface of the insulating material.

In some variations, the heating element may be embedded in and/or may be attached to the surface of an insulating material. In such variations, it may be relatively easy to apply the heating element disclosed herein to existing exhaust systems as there is already space for the insulating material. The insulating material may insulate the at least a remaining portion of the exhaust system and/or can from the heating element, which reduces or avoids undesirable heating from occurring.

In accordance with a fourth aspect of the disclosure, there is provided an exhaust system comprising at least one of the aforementioned heating elements.

In accordance with a fifth aspect of the disclosure, there is provided a vehicle comprising at least one of the aforementioned heating elements.

### FIGURES

The above and other objects and advantages of the disclosure will be apparent upon consideration of the following detailed description, taken in conjunction with the accompanying drawings, in which:

FIG. 1 shows method steps, in accordance with an example of the disclosure.

FIG. 2 shows method steps, in accordance with an example of the disclosure.

FIG. 3 shows method steps, in accordance with an example of the disclosure.

FIG. 4 shows method steps, in accordance with an example of the disclosure.

FIG. 5 shows method steps, in accordance with an example of the disclosure.

FIG. 6 shows a schematic diagram of a catalytic converter, a support mat and heating elements for providing heat to a catalyst of a catalytic converter, in accordance with an example of the disclosure.

FIG. 7 shows a schematic diagram of a catalytic converter, heating elements and a control system for providing heat to a catalyst of a catalytic converter, in accordance with an example of the disclosure.

FIG. 8 shows a schematic diagram of a vehicle and an exhaust system having a heating element for providing heat to a catalyst of a catalytic converter, in accordance with an example of the disclosure.

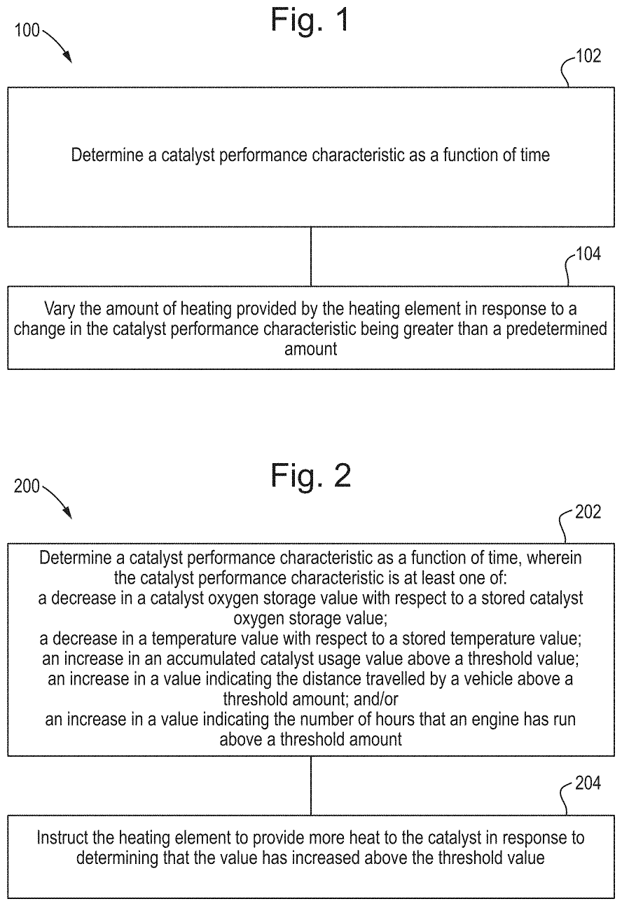

FIG. 1 describes a method 100 of controlling a heating element for providing heat to a catalyst of a catalytic converter. At 102 a catalyst performance characteristic, as a function of time, is determined. At 104, the amount of heating provided by the heating element is varied in response to a change in the catalyst performance characteristic being greater than a predetermined amount. In general, a catalyst performance characteristic is any value that can be measured and used to infer a decrease in catalyst performance.

FIG. 2 describes a method 200 of controlling a heating element for providing heat to a catalyst of a catalytic converter. At 202 a catalyst performance characteristic, as a function of time, is determined, wherein the catalyst performance characteristic is at least one of: a decrease in a catalyst oxygen storage value with respect to a stored catalyst oxygen storage value, a decrease in a temperature value with respect to a stored temperature value, an increase in an accumulated catalyst usage value above a threshold value, an increase in a value indicating the distance travelled by a vehicle above a threshold amount, and an increase in a value indicating the number of hours that an engine has run above a threshold amount. At 204 the heating element is instructed to provide more heat to the catalyst in response to determining that the value has increased above the threshold value.

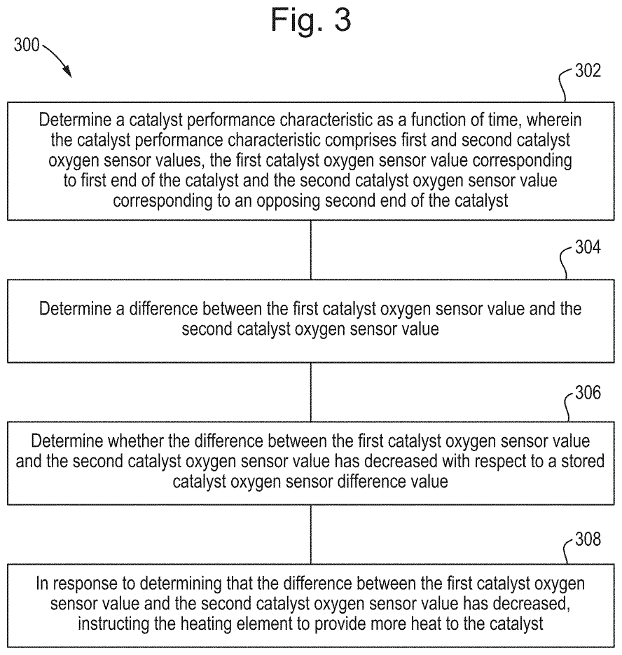

FIG. 3 describes a method 300 of controlling a heating element for providing heat to a catalyst of a catalytic converter. At 302 a catalyst performance characteristic, as a function of time, is determined, wherein the catalyst performance characteristic comprises first and second catalyst oxygen sensor values, the first catalyst oxygen sensor value corresponding to first end of the catalyst and the second catalyst oxygen sensor value corresponding to an opposing second end of the catalyst. At 304 a difference between the first catalyst oxygen sensor value and the second catalyst oxygen sensor value is determined. At 306 it is determined whether the difference between the first catalyst oxygen sensor value and the second catalyst oxygen sensor value has decreased with respect to a stored catalyst oxygen sensor difference value. At 308, in response to determining that the difference between the first catalyst oxygen sensor value and the second catalyst oxygen sensor value has decreased, the heating element is instructed to provide more heat to the catalyst.

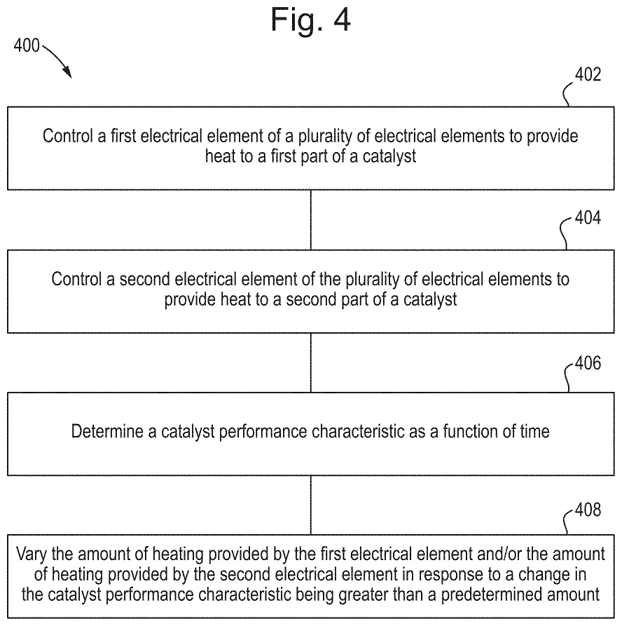

FIG. 4 describes a method 400 of controlling a heating element for providing heat to a catalyst of a catalytic converter. At 402 a first electrical element of a plurality of electrical elements is controlled to provide heat to a first part of a catalyst. At 404 a second electrical element of the plurality of electrical elements is controlled to provide heat to a second part of a catalyst. At 406 a catalyst performance characteristic is determined, as a function of time. At 408 the amount of heating provided by the first electrical element and/or the amount of heating provided by the second electrical element is varied in response to a change in the catalyst performance characteristic being greater than a predetermined amount. In general, a catalyst performance characteristic is any value that can be measured and used to infer a decrease in catalyst performance.

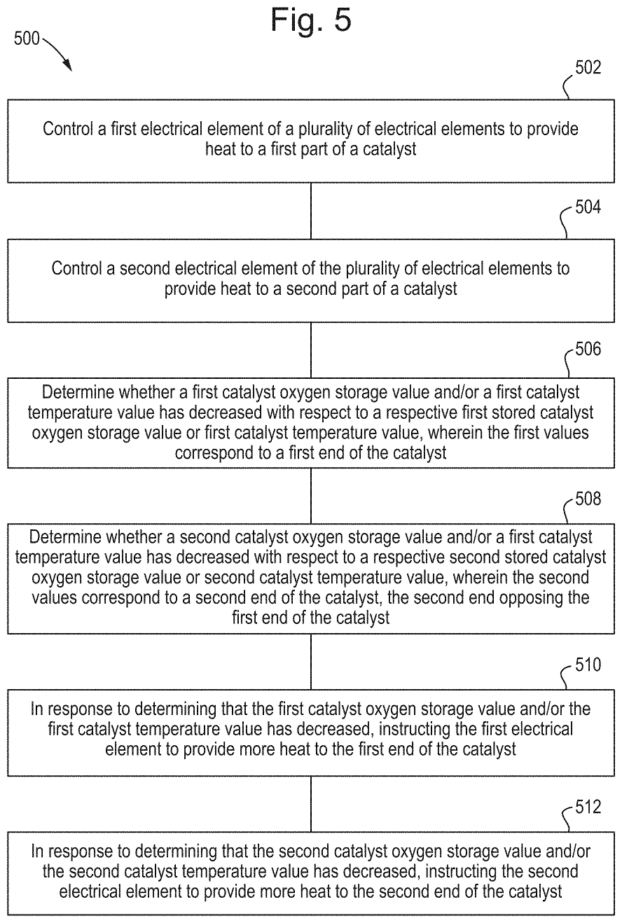

FIG. 5 describes a method 500 of controlling a heating element for providing heat to a catalyst of a catalytic converter. At 502, a first electrical element of a plurality of electrical elements is controlled to provide heat to a first part of a catalyst. At 504, a second electrical element of the plurality of electrical elements is controlled to provide heat to a second part of a catalyst. At 506, it is determined whether a first catalyst oxygen storage value and/or a first catalyst temperature value has decreased with respect to a respective first stored catalyst oxygen storage value or first catalyst temperature value, wherein the first values correspond to a first end of the catalyst. At 508 it is determined whether a second catalyst oxygen storage value and/or a first catalyst temperature value has decreased with respect to a respective second stored catalyst oxygen storage value or second catalyst temperature value, wherein the second values correspond to a second end of the catalyst, the second end opposing the first end of the catalyst. At 510, in response to determining that the first catalyst oxygen storage value and/or the first catalyst temperature value has decreased, the first electrical element is instructed to provide more heat to the first end of the catalyst. At 512, in response to determining that the second catalyst oxygen storage value and/or the second catalyst temperature value has decreased, the second electrical element is instructed to provide more heat to the second end of the catalyst.

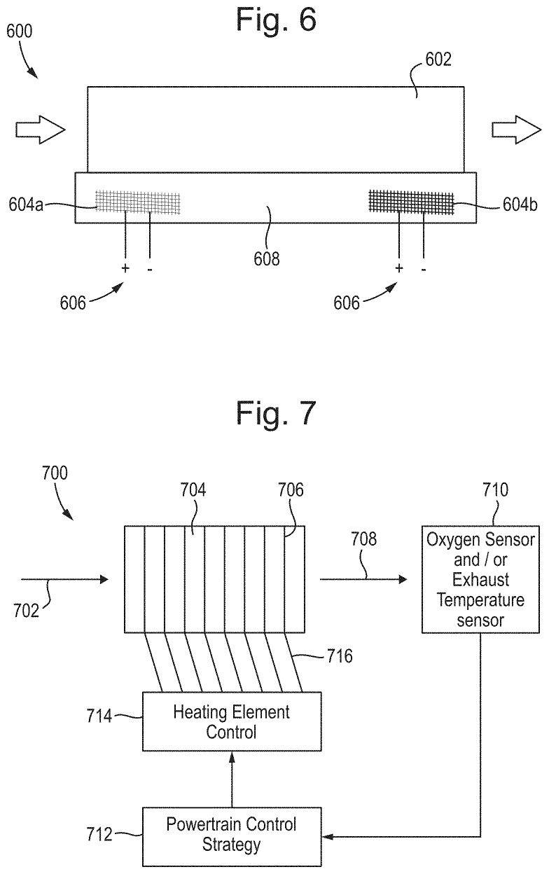

FIG. 6 is a schematic diagram of a catalytic converter 602, heating elements 604a and 604b, a control element and power supply 606 and a support element 608 for providing heat to a catalyst of a catalytic converter. Exhaust gases pass through and/or over the catalytic converter 602 as indicated by the arrows. The heating elements 604a and 604b are used to apply heat to the catalyst. In this example there are two heating elements 604, but there may be any number of heating elements, such as three, four, five or ten. The heating elements may be located at any surface of the catalytic converter. The heating elements may be controlled by instructions executed on a computing device comprising a memory and a processor. The heating elements may make use of resistive heating to heat the catalyst of the catalytic converter 602. In some examples, at least some of the heating elements may be located inside of the catalytic converter. The support element 608 may help to hold the catalytic converter 602 in place in the exhaust system, for example inside a can. The support element may be a support mat comprising fibers that are woven or compressed. The support mat may have insulating properties. The support element may encircle the catalytic converter such that all of or part of the surface of the catalytic converter is covered by the support mat. The heating element 604a is an example wherein the heating element 604a is embedded in the insulating material. The heating element 604b is an example wherein the heating element 604b is attached to a surface of the insulating material. Although the figure shows two different types of heating element 604a, 604b in conjunction with a single catalytic converter 602, examples where there are one or more heating elements of the same type (i.e. embedded in the insulating material or attached to the surface of the insulating material) are also contemplated.

FIG. 7 is a schematic diagram of a catalytic converter 700, heating elements 706 and a control system for providing heat to a catalyst 704 of the catalytic converter 700. Exhaust gases enter the catalytic converter 700 at a first end, pass through and/or over the catalyst 704 and exit the catalytic converter 700 at a second end as indicated by the arrows 702, 708. The heating elements 706 are used to apply heat to the catalyst 704. In this example there are eight heating elements 706, but there may be any number of heating elements, such as two, three, four, five or ten. The heating elements may be located at any surface of the catalytic converter.

In this example, an oxygen sensor and/or exhaust temperature sensor 710 monitors the exhaust gas that exits the catalytic converter 700. The output of the sensor 710 is communicated to a computing device comprising a memory and a processor, which executes instructions to implement a powertrain control strategy 712.

In some examples, greater heating is applied in the front area of the catalyst 704 with the heating progressively increased along the catalyst 704 as it ages. Such a heating strategy allows specific areas of the catalyst 704 to be heated to address relative aging of the catalyst 704, for example the part of the catalyst 704 that receives the exhaust gas flow may age faster than the part of the catalyst that is proximate the exhaust gas flow exit. In addition, based on the output from the exhaust temperature and/or the oxygen sensor 710, if the catalyst conversion efficiency starts to reduce due to cooling of the exhaust, additional heating could be applied by the heating elements 706 to the rear of the catalyst 704, which would typically be at an overall lower temperature compared to the front of the catalyst. This is due to the exhaust gases losing heat as they progress through/along the catalyst 704.

The computing device instructs the heating element control 714 to heat one or more of the heating elements 706 in accordance with the powertrain control strategy 712. Generally, a new catalyst will have a lower heating requirement than a relatively old catalyst. The amount of catalyst heating is determined by the computing device and is dependent on the output of the oxygen sensor and/or temperature sensor 710 and/or a model of catalyst aging that is implemented by the computing device.

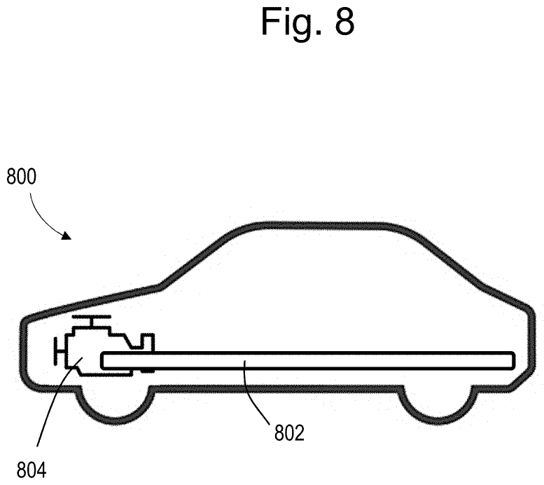

FIG. 8 shows a schematic diagram of a vehicle 800 having an exhaust system 802 attached to an engine 804. The exhaust system 802 takes exhaust gases away from the engine 804 and comprises a catalytic converter. The catalytic converter has one or more heating elements for providing heat to a catalyst of the catalytic converter. The one or more heating elements may be as described above.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Furthermore, it should be noted that the features and limitations described in any one embodiment and/or example may be applied to any other embodiment and/or example herein, and flowcharts or examples relating to one embodiment and/or example may be combined with any other embodiment and/or example in a suitable manner, done in different orders, or done in parallel. In addition, the systems and methods described herein may be performed in real time. It should also be noted that the systems and/or methods described above may be applied to, or used in accordance with, other systems and/or methods.

1. A method of controlling a heating element for providing heat to a catalyst of a catalytic converter, wherein the catalytic converter is configured to be coupled to an engine, the method comprising:
determining a catalyst performance characteristic as a function of time, wherein the catalyst performance characteristic comprises a value indicating a number of hours the engine has run;
determining whether the value indicating the number of hours the engine has run has increased above a threshold value; and
in response to determining that the value indicating the number of hours the engine has run has increased above the threshold amount value, varying the amount of heating provided by the heating element.

2. The method of claim 1, wherein the catalyst performance characteristic comprises a catalyst oxygen storage value, the method further comprising:
determining whether the catalyst oxygen storage value has decreased with respect to a stored catalyst oxygen storage value; and
in response to determining that the catalyst oxygen storage value has decreased, instructing the heating element to provide more heat to the catalyst.

3. The method of claim 1, wherein the catalyst performance characteristic comprises first and second catalyst oxygen sensor values, the first catalyst oxygen sensor value corresponding to a first end of the catalyst and the second catalyst oxygen sensor value corresponding to an opposing second end of the catalyst, the method further comprising:
determining a difference between the first catalyst oxygen sensor value and the second catalyst oxygen sensor value;
determining whether the difference between the first catalyst oxygen sensor value and the second catalyst oxygen sensor value has decreased with respect to a stored catalyst oxygen sensor difference value; and
in response to determining that the difference between the first catalyst oxygen sensor value and the second catalyst oxygen sensor value has decreased, instructing the heating element to provide more heat to the catalyst.

4. The method of claim 1, wherein the catalyst performance characteristic comprises a temperature value, the method further comprising:
determining whether the temperature value has decreased with respect to a stored temperature value; and in response to determining that the temperature value has decreased, instructing the heating element to provide more heat to the catalyst.

5. The method of claim 1, wherein the catalyst performance characteristic comprises an accumulated catalyst usage value, the method further comprising:
determining whether the accumulated catalyst usage value has increased above a threshold value; and
in response to determining that the accumulated catalyst usage value has increased above the threshold value, instructing the heating element to provide more heat to the catalyst.

6. The method of claim 1, wherein the catalytic converter is part of a vehicle and the catalyst performance characteristic comprises a value indicating a distance travelled by the vehicle, the method further comprising:
determining whether the value indicating the distance travelled by the vehicle has increased above a threshold value; and
in response to determining that the value indicating the distance travelled by the vehicle has increased above the threshold value, instructing the heating element to provide more heat to the catalyst.

7. The method of claim 1, wherein the catalyst performance characteristic comprises a value indicating a number of hours the engine has run, the method further comprising,
in response to determining that the value indicating a number of hours the engine has run has increased above the threshold amount, instructing the heating element provide more heat to the catalyst.

8. A method of controlling a heating element for providing heat to a catalyst of a catalytic converter, the heating element comprising a plurality of independently controllably electrical elements, the method comprising:
controlling a first electrical element of the plurality of electrical elements to provide heat to a first part of the catalyst;
controlling a second electrical element of the plurality of electrical elements to provide heat to a second part of the catalyst;
determining a catalyst performance characteristic as a function of time; and
varying an amount of heating provided by at least one of the first electrical element and the amount of heating provided by the second electrical element in response to a change in the catalyst performance characteristic being greater than a predetermined amount.

9. The method of claim 8, wherein the catalyst performance characteristic comprises first and second catalyst oxygen storage values, the first catalyst oxygen storage value corresponding to a first end of the catalyst and the second catalyst oxygen storage value corresponding to an opposing second end of the catalyst, the method further comprising:
determining whether the first catalyst oxygen storage value has decreased with respect to a first stored catalyst oxygen storage value;
determining whether the second catalyst oxygen storage value has decreased with respect to a second stored catalyst oxygen storage value;
in response to determining that the first catalyst oxygen storage value has decreased, instructing the first electrical element to provide more heat to the first end of the catalyst; and
in response to determining that the second catalyst oxygen storage value has decreased, instructing the second electrical element to provide more heat to the second end of the catalyst.

10. The method of claim 8, wherein the catalyst performance characteristic comprises first and second catalyst temperature values, the first catalyst temperature value corresponding to a first end of the catalyst and the second catalyst temperature value corresponding to an opposing second end of the catalyst, the method further comprising:
determining whether the first catalyst temperature value has decreased with respect to a first stored temperature storage value;
determining whether the second catalyst temperature value has decreased with respect to a second stored catalyst temperature storage value;
in response to determining that the first catalyst temperature value has decreased, instructing the first electrical element to provide more heat to the first end of the catalyst; and
in response to determining that the second catalyst temperature value has decreased, instructing the second electrical element to provide more heat to the second end of the catalyst.

11. A heating element for providing heat to a catalyst of a catalytic converter, the heating element comprising a plurality of independently controllable electrical elements configured, in use, to provide a first electrical element of the plurality of electrical elements a first amount of heat to a first part of the catalyst and a second electrical element of the plurality of electrical elements can provide a second amount of heat to a second part of the catalyst, the heating element comprising a memory storing instructions and control circuitry communicably coupled to the memory and configured to execute instructions to vary an amount of heating provided by at least one of the first electrical element, in use, and the amount of heating provided by the second electrical element, in use, in response to a change in a determined catalyst performance characteristic being greater than a predetermined amount.

12. The heating element of claim 11, wherein the catalytic converter comprises an insulating material and at least a part of the heating element is embedded the insulating material.

13. The heating element of claim 11, wherein the catalytic converter comprises an insulating material and at least a part of the heating element is attached to a surface of the insulating material.

14. An exhaust system comprising the heating element of claim 11.

15. A vehicle comprising the heating element of claim 11.
